(19) United States
(12) Patent Application Publication
(10) Pub. No.: US 2026/0185688 A1
(43) Pub. Date: Jul. 2, 2026

(54) MODULAR LIGHTING STRUCTURE AND LIGHTING CONTROL SYSTEM USING THE SAME

(71) Applicant: LEOTEK CORPORATION, Taipei City (TW)

(72) Inventor: Shih-Hung LO, Taipei City (TW)

(21) Appl. No.: 19/194,078

(22) Filed: Apr. 30, 2025

(30) Foreign Application Priority Data
Jan. 2, 2025 (TW) 114100108

(51) Int. Cl. F21V 23/00; F21V 31/00

(52) U.S. Cl. CPC F21V 23/009; F21V 23/006; F21V 31/005

(57) ABSTRACT

A modular lighting structure includes a lamp cover, a lighting control box, a lighting power module and a light engine. The lamp cover includes a housing and a mounting hole penetrating the housing. The lighting control box includes a box body, a fixing base and a fastener. The box body is arranged on the lamp cover, and the fixing base is arranged on an axial line of the mounting hole. The fastener is located at the bottom of the box body, passes through the mounting hole and is fixed on the fixing base. The lighting power module is disposed in the housing. The lighting power module is configured to receive an AC power and output a DC power to the light engine. The lighting control box is configured to receive a DC power from the lighting power module.

This application claims the benefit of Taiwan application Serial No. 114100108, filed Jan. 2, 2025, the subject matter of which is incorporated herein by reference.

### BACKGROUND OF THE INVENTION

### Field of the Invention

The invention relates in general to a lighting, and more particularly to a modular lighting structure and a lighting control system using the same

### Description of the Related Art

With the increasing advancement of LED lighting technology, advanced, efficient and reliable power line carrier communication (PLCC) technology is used to achieve remote centralized control and management of lighting equipment, which has functions including automatic brightness adjustment, remote lighting control, active fault alarm, line inspection, etc., greatly improving the equipment management level and saving maintenance costs.

Digital Addressable Lighting Interface (DALI) lightings have two-way communication capabilities and can detect devices within the DALI system. It can not only record the energy consumption of each light source, but also detect status of ballasts and light sources for easy management and maintenance. DALI system is almost a necessary specification for the current mainstream building automation equipment management system (i.e., Building Management System; BMS). In addition, DALI is an open and digital standard, so the lighting system built using DALI can be compatible with products from different manufacturers and can also be easily integrated into other digital systems.

The most significant feature of DALI lightings is that each lighting has an independent address, and precise dimming control can be performed on a single lighting or a group of lightings through the DALI system. Software of DALI system can address single or multiple lightings on the same circuit or different circuits, so as to achieve individual control and arbitrary grouping. Therefore, the DALI lighting system brings great flexibility to intelligent lighting control.

### SUMMARY OF THE INVENTION

The invention is directed to a modular lighting structure and a lighting control system using the same, which can reduce the complexity of wiring and improve the efficiency of lighting installation.

According to one aspect of the present invention, a modular lighting structure is provided, including a lamp cover, a lighting control box, a lighting power module and a light engine. The lamp cover includes a housing and a mounting hole penetrating the housing. The lighting control box includes a box body, a fixing base and a fastener. The box body is arranged on the lamp cover, and the fixing base is arranged on an axial line of the mounting hole. The fastener is located at the bottom of the box body, and the fastener is fixed on the fixing base via the mounting hole. The lighting power module is arranged in the housing, and is configured for receiving an AC power and outputting a DC power to the light engine. The lighting control box has an input terminal which is electrically connected to the lighting power module and is configured for receiving a DC power from the lighting power module.

According to one aspect of the present invention, a lighting control system is provided. The lighting control system includes a lighting power supply module, a DC-DC converter module, a wireless communication module and a microcontroller module. The lighting power module is configured to receive an alternating current and output a direct current (DC) to a light engine. The DC-DC converter module is electrically connected to the wireless communication module, the microcontroller module and the lighting power module respectively, wherein the DC-DC converter module has an input terminal and an output terminal. The input terminal is electrically connected to the lighting power module to receive a DC power from the lighting power module, and the output terminal is electrically connected to the wireless communication module and the microcontroller module, respectively.

According to one aspect of the present invention, a replaceable lighting control box is provided. The replaceable lighting control box includes a box body, a fastener, a fixing base and a power connector integrated connection terminal. The box body includes an upper cover and a lower cover, a circuit board is arranged in the box body and a through hole for externally connecting is arranged in the lower cover. The fastener is arranged on the lower cover and protrudes from the bottom surface of the box body, and the fastener has an annular portion and at least one buckle structure. The fixing base has an annular groove base and at least one positioning groove block. The annular groove base is suitable for being assembled with the annular portion, and the buckle structure is suitable for being buckled with the positioning groove block. The power connector integrated connection terminal passes through an opening of the annular groove base, an opening of the fastener, a mounting hole of a lighting and the through hole for externally connecting on the box body to be electrically connected upward to the circuit board.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIGS. 1A and 1B are schematic diagrams of a lighting control box at different viewing angles according to an embodiment of the present invention.

FIG. 2 is an exploded view of a lighting control box according to an embodiment of the present invention.

FIG. 3 is an exploded view of the lighting control box of FIG. 2 assembled on the lamp cover.

FIG. 4 is a schematic cross-sectional view of the lighting control box and lamp cover of FIG. 3 along line A-A′.

FIGS. 5A and 5B are exploded views of a modular lighting structure at different viewing angles according to an embodiment of the present invention.

FIG. 6 is a circuit block diagram of a modular lighting structure according to an embodiment of the present invention.

FIG. 7 is a circuit block diagram of a lighting control system according to an embodiment of the present invention.

### DETAILED DESCRIPTION OF THE INVENTION

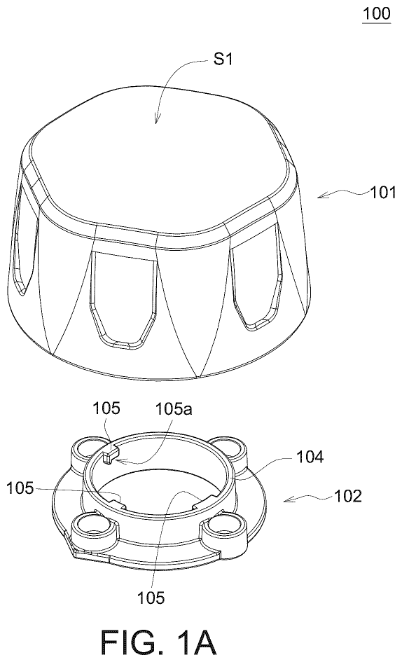

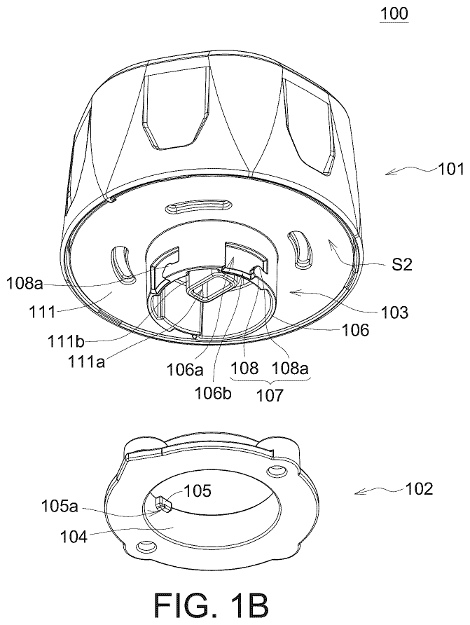

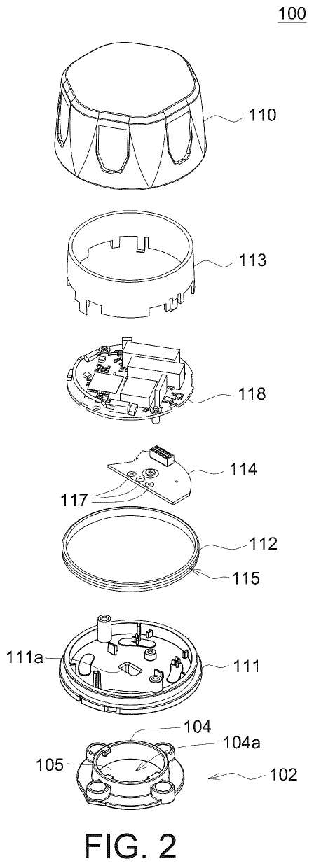

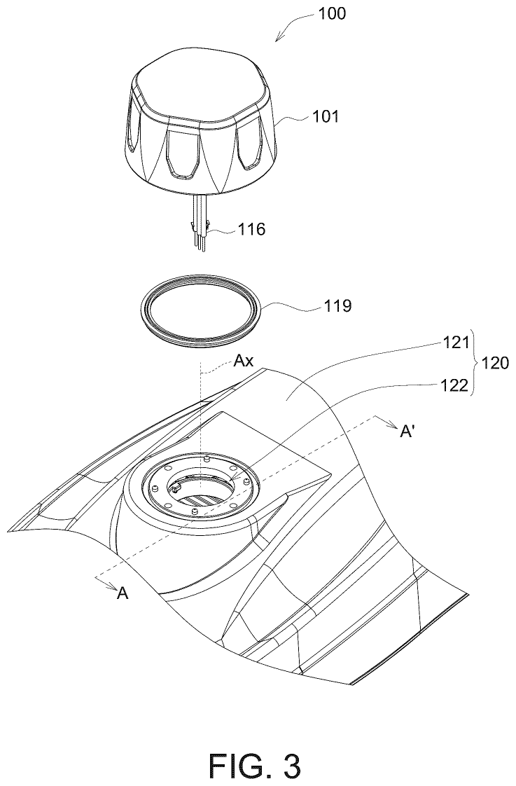

Referring to FIGS. 1A, 1B, 2, and 3, FIGS. 1A and 1B are schematic diagrams of a lighting control box 100 at different viewing angles according to an embodiment of the present invention, and FIG. 2 is an exploded view of a lighting control box 100 according to an embodiment of the present invention. FIG. 3 is an exploded view of the lighting control box 100 of FIG. 2 assembled on the lamp cover 120.

Referring to FIGS. 1A and 1B, the lighting control box 100 includes a box body 101, a fixing base 102 and a fastener 103. The box body 101 is disposed on the lamp cover 120 (see FIG. 3), for example, disposed on the top surface of the lamp cover 120. The box body 101 has a storage space inside for placing control devices, voltage conversion devices and/or communication devices, etc. Referring to FIG. 7, the control device is, for example, a microcontroller module 144, the voltage conversion device is, for example, a DC-DC converter module 140, and the communication device is, for example, a wireless communication module 142, such as a Wi-Fi module.

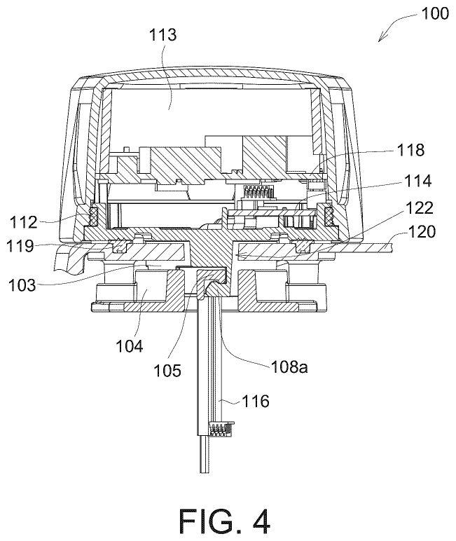

Referring to FIG. 2, the box body 101 has an upper cover 110, a lower cover 111 and a waterproof strip 112. The upper cover 110 covers the lower cover 111 and the waterproof strip 112, and the waterproof strip 112 seals a surrounding area of a joint between the upper cover 110 and the lower cover 111. In one embodiment, the waterproof strip 112 is an O-shaped waterproof ring, and the outer side thereof has one or more layers of waterproof convex structures 115 (also called corrugated waterproof ring). The waterproof convex structures 115 are connected up and down and abut against the inner wall of the upper cover 110 and the outer wall of the lower cover 111 (see FIG. 4) to achieve a multi-layer sealing and waterproof effect.

In addition, referring to FIG. 2, the box body 101 may contain an antenna module 113, a circuit board 114, and a main board 118. The antenna module 113 is configured to receive external radio signals and the radio signals are converted into electronic signals required by the wireless communication module 142 to achieve the remote control function. In one embodiment, the antenna module 113 adopts a loop antenna. The loop-shaped reception of the antenna can have a better field pattern and a better signal reception bandwidth. The antenna module 113 also adopts a modular design and is easy to assemble and disassemble. The circuit board 114 is configured to receive an external power signal and connect to internal electronic devices to provide the operating voltages required by the control devices, voltage conversion devices and/or communication devices. The main board 118 is configured to carry and electrically connect the DC-DC converter module 140, the microcontroller module 144 and the wireless communication module 142. The functions and features of the electronic devices such as the DC-DC converter module 140, the microcontroller module 144 and the wireless communication module 142 will be described in the following content, and only the external structure and feature of the lighting control box 100 are described here.

Referring to FIGS. 1A and 1B, the box body 101 has a top surface S1 and a bottom surface S2. The fastener 103 is disposed at the bottom of the box body 101 and protrudes from the bottom surface S2 of the box body 101. The fastener 103, for example, has an annular portion 106 and a plurality of buckle structures 107. For example, three buckle structures 107 are disposed around the annular portion 106. The fastener 103 can be disposed on the fixing base 102 via at least one buckle structure 107. As shown in FIGS. 1A and 1B, the fixing base 102 has an annular groove base 104 and a plurality of positioning groove blocks 105. The annular groove base 104 is disposed below the box body 101, and the shape of the annular groove base 104 matches the shape of the annular portion 106 of the fastener 103, so that the fastener 103 can be inserted into the annular groove base 104.

The positioning groove block 105 is arranged on the inner ring surface of the annular groove base 104, and the position and shape of the positioning groove block 105 match the position and shape of the buckle structure 107, so that the positioning groove block 105 and the corresponding buckle structure 107 can combine together. As shown in FIG. 1B, the buckle structure 107 includes a rod 108 protruding toward a notch 106a. The front end of the rod 108 has a protrusion 108a to form a limiting structure for a groove 105a of the positioning groove block 105 on the fixing base 102. The detailed installation steps are as follows: at first, an opening end 106b of the notch 106a is aligned with the positioning groove block 105 on the fixing base 102 so that the positioning groove block 105 can enter the notch 106a through the opening end 106b. Then, the box body 101 of the lighting control box 100 is rotated clockwise, for example, so that the positioning groove block 105 moves toward the rod 108 until the positioning groove block 105 interferes with the protrusion 108a located at the front end of the rod 108 in the moving direction. Next, the box body 101 of the lighting control box 100 is continuously rotated to overcome the interference force until the groove 105a of the positioning groove block 105 is engaged with the protrusion 108a of the rod 108. Therefore, through the buckle structure 107 and the positioning groove block 105 of the fixing base 102, the box body 101 of the lighting control box 100 can be fastened on the lamp cover 120 shown in FIG. 3 or disassemble from the lamp cover 120 without tools.

Referring to FIG. 3, the lamp cover 120 includes a housing 121 and a mounting hole 122 penetrating the housing 121. A waterproof gasket 119 is disposed around the mounting hole 122, such as an O-shaped waterproof ring having one or more layers of waterproof convex structures (also known as a corrugated waterproof ring) to seal a surrounding area of the joint between the housing 121 and the box body 101 so as to prevent moisture from entering. The box body 101 of the lighting control box 100 is disposed above the mounting hole 122, and the fixing base 102 of the lighting control box 100 is disposed below the mounting hole 122. That is to say, the box body 101 of the lighting control box 100 is disposed outside the housing 121, and the fixing base 102 of the lighting control box 100 is disposed inside the housing 121. In this embodiment, the fastener 103 of the lighting control box 100 can be inserted downward to the bottom of the mounting hole 122 and engaged with the fixing base 102 located below the mounting hole 122 (see FIG. 4). The installation steps are mentioned above, no further details will be illustrated here. However, the lighting control box 100 can be installed on a housing of a lighting fixture such as a street lamp, a street lighting or other places, or on a pole, a rack or other parts unrelated to the lighting, such as a parking meter, electric poles or other parts, and the embodiment is not limited thereto.

Referring to FIGS. 2 and 4, FIG. 4 is a schematic cross-sectional view of the lighting control box 100 and the lamp cover 120 of FIG. 3 along line A-A′. An antenna module 113 and a circuit board 114 are disposed inside the lighting control box 100. The circuit board 114 has a power connector 117, which is connected to an integrated connection terminal 116. For example, three power connectors 117 are respectively connected to the three-core plug-in cables on the integrated connection terminal 116. The integrated connection terminal 116 passes through the lower cover 111 and the fixing base 102 and extends downward to the inside of the housing 121 of the lamp cover 120 to receive power. In other words, the lower cover 111 is provided with a through hole 111a for external connecting, and the external protection structure 111b of the box body 101 (see FIG. 1B) extends outwardly corresponding to the through hole 111a and protrudes from the bottom surface S2 of the box body 101. The external protection structure 111b is located in the annular portion 106, and the annular groove base 104 of the fixing base 102 is provided with an opening 104a corresponding to the fastener 103. The through hole 111a is located on the axial line Ax of the mounting hole 122. The circuit board 114 is provided in the box body 101, and the power connector integrated connection terminal 116 passes through the opening 104a of the annular groove 104, the mounting hole 122 of the lighting housing 121, and the through hole 111a of the lower cover 111 in order and is electrically connected to the power connector 117 of the circuit board 114.

In addition, the external protection structure 111b accommodates the integrated connection terminal 116 through the through hole 111a. The periphery of the integrated connection terminal 116 exposed at the through hole 111a can be sealed with glue to maintain the sealing of the lighting control box 100 so as to prevent moisture from entering.

Compared with the traditional lighting control box, it needs to install an alternating current (AC) meter and AC/DC converter module inside the box body to convert AC power into DC power, and then provide DC power to the inside of the lamp cover through the circuit board and cable. The lighting control box 100 of the present disclosure does not need to additionally set up an AC meter and an AC/DC converter module inside the box body 101, but directly converts the AC power to DC power through the lighting power module 130 outside the lighting control box 100. The AC power is converted into DC power, which is then input to the circuit board 114 in the lighting control box 100 through the cables of the integrated connection terminal 116 to provide the operating voltages required by the control devices, voltage conversion devices and/or communication devices in the lighting control box 100.

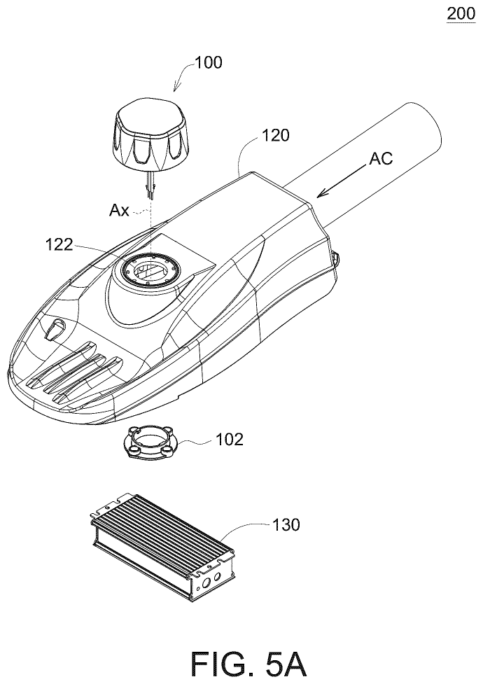

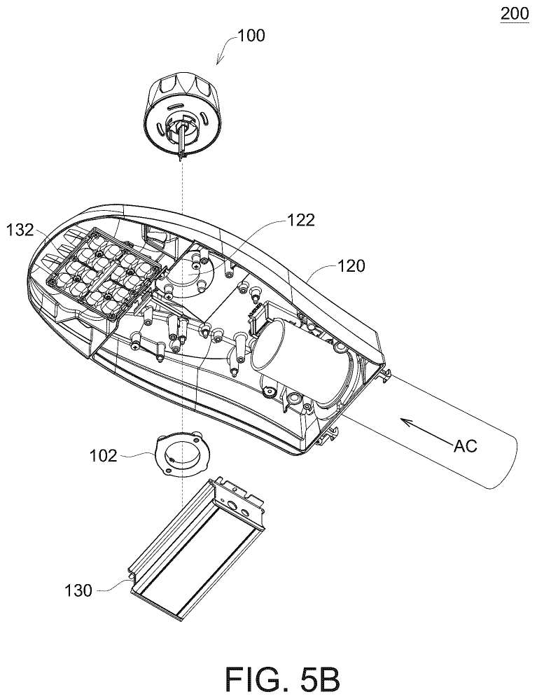

Referring to FIGS. 5A and 5B, FIGS. 5A and 5B are exploded views of a modular lighting structure 200 at different viewing angles according to an embodiment of the present invention. The modular lighting structure 200 may be a DALI lighting or a street lamp, and is configured to implement remote centralized control and management of lighting equipment. The modular lighting structure 200 includes a lamp cover 120, a lighting control box 100, a lighting power module 130 and a light engine 132. The lamp cover 120 includes a housing 121 and a mounting hole 122 penetrating the housing 121. The lighting control box 100 includes a box body 101, a fixing base 102 and a fastener 103. The box body 101 is disposed on the lamp cover 120, and the fixing base 102 is disposed on an axial line Ax of the mounting hole 122. For example, the fixing base 102 is fixed below the mounting hole 122 by screws.

In addition, the fastener 103 is located at the bottom of the box body 101, and the fastener 103 is fixed on the fixing base 102 via the mounting hole 122. The installation steps of the lighting control box 100 have been described in the above-mentioned embodiment, please refer to FIGS. 1A to 4, and will not be repeated here.

Referring to FIGS. 5A and 5B. The lighting power module 130 is disposed in the housing 121. The lighting power module 130 is configured to receive an AC power and output a DC power to the light engine 132. In one embodiment, the AC power is, for example, mains power supply, and its voltage may be 110 volts. The AC power can be transmitted to the location of the modular lighting structure 200 via the power line system and input into the lighting power module 130. In one embodiment, the lighting power module 130 can provide the DC power DC1 (e.g., 0-10V) required by the light engine 132 and the DC power DC2 (e.g., 3.3V-12V) required by the lighting control box 100. The DC power DC2 is input to the lighting control box 100 through a plurality of cables of the integrated connection terminal 116, so the lighting control box 100 does not need to additionally set an AC meter and an AC/DC converter module inside the box body 101.

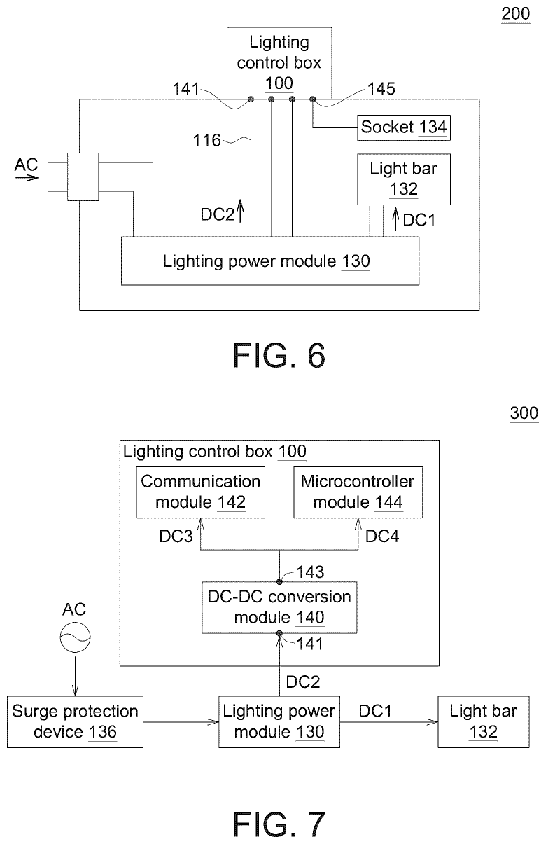

Referring to FIGS. 6 and 7, FIG. 6 is a circuit block diagram of a modular lighting structure 200 according to an embodiment of the present invention, and FIG. 7 is a circuit block diagram of a lighting control system 300 according to an embodiment of the present invention. In FIG. 6, the lighting power module 130 is configured to receive an AC power and output a DC power DC1 to the light engine 132. In addition, the lighting control box 100 has an input terminal 141, which is electrically connected to the lighting power module 130 for receiving a DC power DC2 from the lighting power module 130. In addition, an auxiliary socket 134, such as an RS485 socket, may be disposed inside the lamp cover 120 to provide power and/or signals to other additional lightings or accessories, such as traffic lights. The auxiliary socket 134 is connected to an output terminal 145 of the lighting control box 100 for receiving a DC power and/or a control signal from the lighting control box 100.

Referring to FIG. 7, the lighting control system is, for example, a DALI lighting control system 300, which is configured to implement remote centralized control and management of lighting equipment. The lighting control system 300 includes a lighting power module 130 and a lighting control box 100. The lighting control box 100 includes a DC-DC converter module 140, a wireless communication module 142 and a microcontroller module 144. The lighting power module 130 is connected to a surge protection device 136. The surge protection device 136 is configured to receive an AC power, such as 110V mains power supply, to prevent the lighting from being damaged by a transient impulse voltage. The lighting power module 130 receives the AC power and outputs a DC power DC1 to the light engine 132. The light engine 132 is, for example, an adjustable light emitting diode (LED) light engine, and the light engine 132 can adjust the brightness of the LEDs according to the magnitude of the driving current. In addition, the DC-DC converter module 140 is electrically connected to the wireless communication module 142, the microcontroller module 144 and the lighting power module 130, respectively. The DC-DC converter module 140 has an input terminal 141 and an output terminal 143. The input terminal 141 is electrically connected to the lighting power module 130, and the output terminal 143 is electrically connected to the wireless communication module 142 and the microcontroller module 144, respectively.

In one embodiment, the lighting power module 130 is, for example, a DALI power module, which converts an AC power (110V) into a DC power (e.g., 12V) for supporting the DALI protocol through amplification and isolation of a transistor circuit. In addition, the DC-DC converter module 140 can convert a DC power DC2 (e.g., 12V) into DC powers DC3 and DC4 (e.g., 3.3V-5V) required by the wireless communication module 142 and the microcontroller module 144, respectively.

The microcontroller module 144 is, for example, a chip package module, which may include a central processing unit (CPU) or other general-purpose processor, a digital signal processor (DSP), an application specific integrated circuit (ASIC), a field-programmable gate array (FPGA) or other programmable logic devices, discrete gate or transistor logic devices, discrete hardware devices, etc.

The wireless communication module 142 may be a Wi-Fi module. In one embodiment, a gateway of the Wi-Fi module is connected to a server via a wireless Wi-Fi network. The server sends lighting on/off, brightness control or other control commands to the gateway according to the specified data format. After receiving the data, the gateway parses the data according to the specified format. After parsing, the address of the controlled lighting is obtained and the command is actually issued. The command includes on/off commands or light intensity adjustments. Then, the gateway converts the data into the standard DALI format according to the DALI standard communication data format. The DALI standard communication data consists of address bits and command bits and is sent to standard DALI lightings. When the corresponding command is received, the DALI lightings will be controlled. If it is a light on/off command, the power to the DALI lighting will be turned on or off. If it is a brightness command, it will be adjusted according to the brightness setting, for example, using pulse width modulation (PWM) dimming to adjust the brightness.

Therefore, the modular lighting structure 200 and the lighting control system 300 disclosed in the embodiment can effectively reduce power consumption and improve the overall operating efficiency of the lighting system. In addition, the modular lighting structure 200 and the lighting control system 300 disclosed in the embodiment can simplify the circuit configuration between the lighting control box 100 and the lighting power module 130, and there is no need to provide additional AC power to the lighting control box 100. The lighting power module 130 directly provides the DC power DC2 to the lighting control box 100, thereby reducing the complexity of wiring and improving the efficiency of lighting installation.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A modular lighting structure, comprising:
a lamp cover including a housing and a mounting hole extending through the housing;
a lighting control box engaged with the lamp cover, wherein the lighting control box includes a box body, a fixing base and a fastener, the box body is disposed on the lamp cover, the fixing base is disposed on an axial line of the mounting hole, the fastener is located at a bottom of the box body, and the fastener is fixed on the fixing base through the mounting hole;
a lighting power module disposed within the housing; and
a light engine disposed in the housing, wherein the lighting power module is configured to receive an alternating current (AC) power and output a direct current (DC) power to the light engine, the lighting control box has an input terminal electrically connected to the lighting power module and receiving another DC power from the lighting power module.

2. The modular lighting structure as claimed in claim 1, wherein the box body includes an upper cover, a lower cover and at least one waterproof strip, the upper cover covers the lower cover and the waterproof strip, and the waterproof strip seals a surrounding area of the upper cover and the lower cover.

3. The modular lighting structure as claimed in claim 1, wherein the box body has a top surface and a bottom surface, the fastener is disposed at the bottom of the box body and protrudes from the bottom surface of the box body, and the fastener has an annular portion and at least one buckle structure.

4. The modular lighting structure as claimed in claim 3, wherein the fixing base has an annular groove base and at least one positioning groove block, the annular groove base is arranged at the bottom of the box body, a shape of the annular groove base matches a shape of the annular portion, and the buckle structure is suitable for being inserted into the annular groove base and buckled with the positioning groove block.

5. The modular lighting structure as claimed in claim 1, wherein the lighting control box includes a DC-DC converter module, a wireless communication module and a microcontroller module, the DC-DC converter module is electrically connected to the wireless communication module, the microcontroller module and the lighting power module respectively, the DC-DC converter module has the input terminal and an output terminal, the input terminal is electrically connected to the lighting power module, the output terminal is electrically connected to the wireless communication module and the microcontroller module, respectively.

6. The modular lighting structure as claimed in claim 1, wherein the lighting power module is configured to provide the another DC power for supporting digital addressable lighting interface (DALI) protocol.

7. A lighting control system, comprising:
a lighting power module for receiving an alternating current (AC) power and outputting a direct current (DC) power to a light engine;
a DC-DC converter module;
a wireless communication module; and
a microcontroller module, wherein the DC-DC converter module is electrically connected to the wireless communication module, the microcontroller module and the lighting power module respectively, the DC-DC converter module has an input terminal and an output terminal, the input terminal is electrically connected to the lighting power module to receive another DC power from the lighting power module, and the output terminal is electrically connected to the wireless communication module and the microcontroller module, respectively.

8. The lighting control system as described in claim 7, wherein the DC-DC converter module, the wireless communication module and the microcontroller module are installed in a lighting control box.

9. The lighting control system as claimed in claim 8, wherein the lighting control box includes a box body, a fixing base and a fastener, the fastener is arranged on the box body, the fixing base is arranged on a lighting, the box body and the lighting are connected through the fastener and the fixing base or disassembled without tools.

10. The lighting control system as claimed in claim 7, wherein the lighting power module is configured to provide the another DC power for supporting digital addressable lighting interface (DALI) protocol.

11. A replaceable lighting control box, comprising:
a box body, including an upper cover and a lower cover, wherein a circuit board is provided in the box body and the lower cover has a through hole for external connecting;
a fastener disposed on the lower cover and protruding from a bottom surface of the box body, and the fastener having an annular portion and at least a buckle structure;
a fixing base having an annular groove base and at least one positioning groove block, wherein the annular groove base is suitable for assembling with the annular portion, and the buckle structure is suitable for buckling with the positioning groove block; and
a power connector integrated connection terminal passing through an opening of the annular groove base, an opening of the fastener, a mounting hole of a lighting and the through hole of the box body in order and electrically connected to the circuit board.

12. The replaceable lighting control box as claimed in claim 11, wherein the positioning groove block is disposed on an inner ring surface of the annular groove base, the buckle structure includes a rod protruding toward a notch, a front end of the rod having a protrusion forming a limiting structure for a groove of the positioning groove block on the fixing base, the positioning groove block enters the notch through an opening end and engages with the protrusion by a rotating buckle.

13. The replaceable lighting control box as claimed in claim 11, wherein the box body further includes an external protection structure, corresponding to the through hole and extending outwardly and protruding from the bottom surface of the box body and exposed in the opening of the annular groove base.

14. The replaceable lighting control box as claimed in claim 13, wherein the circuit board further includes a power connector, the power connector integrated connection terminal passes through the opening of the fixing base, the mounting hole of the lighting and the through hole of the external protection structure of the box body and is connected to the power connector.

15. The replaceable lighting control box as claimed in claim 11, wherein peripheries of the power connector integrated connection terminal and the external protection structure are sealed with a glue.

16. The replaceable lighting control box as claimed in claim 11, wherein an antenna module is further provided in the box body and surrounds an inner surface of the box body.

17. The replaceable lighting control box as claimed in claim 11, wherein the box body includes an upper cover, a lower cover and at least one waterproof strip, the upper cover covers the lower cover and the waterproof strip, and the waterproof strip seals a location adjacent to the upper cover and the lower cover.

18. The replaceable lighting control box as claimed in claim 17, wherein a waterproof strip is provided around the mounting hole to seal a surrounding area of a joint between the lighting and the box body.

19. The replaceable lighting control box as claimed in claim 11, wherein the box body and the lighting are connected through the at least one buckle structure and the at least one positioning groove block or disassemble from each other without tools.
